(19) United States
(12) Patent Application Publication
(10) Pub. No.: US 2012/0096676 A1
(43) Pub. Date: Apr. 26, 2012

(54) HINGE ASSEMBLY FOR FOLDABLE ELECTRONIC DEVICE

(75) Inventors: JIAN-WEI LI, Shenzhen City (CN); CHAO DUAN, Shenzhen City (CN); CHIA-HUA CHEN, Taipei (TW)

(73) Assignees: FIH (HONG KONG) LIMITED, Kowloon (HK); SHENZHEN FUTAIHONG PRECISION INDUSTRY CO., LTD., ShenZhen City (CN)

(21) Appl. No.: 12/915,039

(22) Filed: Oct. 29, 2010

(30) Foreign Application Priority Data
Oct. 25, 2010 (CN) 201010518192.7

(51) Int. Cl. E05D 11/00; B23P 11/00; E05F 1/12

(52) U.S. Cl. 16/250; 29/11

(57) ABSTRACT

An exemplary hinge assembly includes a sleeve, a first member, a second member, and a resilient member. The sleeve includes a first end defining an opening. The first member is received in the sleeve. The second member is located next to the first member. One of the first member and the second member have a cam, the other of the first member and second member have a cam follower interacting with the cam so that the first member rotates about an axis and the second member moves linearly along the axis when the cam follower follows the cam. The resilient member is fitted in the sleeve and provides an elastic force to bias the first member and the second member into contact with each other. The first end is deformed to form a narrowed portion to reduce the opening. The narrowed portion retains the first member, the second member, and the resilient member in the sleeve and prevents the first member, the second member, and the resilient member from escaping the sleeve through the opening.

### CROSS-REFERENCE TO RELATED APPLICATIONS

This application is related to co-pending U.S. Patent Applications (Attorney Docket Nos. US35011 and US34079, entitled “HINGE ASSEMBLY FOR FOLDABLE ELECTRONIC DEVICE”, by Duan et al., which have the same assignee as the present application. The above-identified applications are incorporated herein by reference.

### BACKGROUND

1. Technical Field

The present disclosure relates to hinge assemblies and, particularly, to a hinge assembly for foldable electronic devices such as mobile phones and portable computers.

2. Description of Related Art

One of the most popular types of portable electronic device in the marketplace is the foldable mobile phone, which generally includes a cover section and a body section. The cover section and the body section are rotatably interconnected through a hinge assembly, allowing the telephone to move between an open position and a closed position.

However, traditional hinge assemblies include a large number of mechanical elements. Thus, the assembly process can be relatively complicated. Another hinge assembly is disclosed in U.S. Pat. No. 6,085,387. The hinge assembly has a can, a first hinge member, a second hinge member and a spring. The can includes an open end. Two protrusions are formed at the open end of the can. After the first hinge member, the second hinge member and the spring are inserted into the can, the two protrusions are bent to partially cover the open end blocking escape of the inserted parts. Since the protrusions need to be pre-formed, the manufacture of the sleeve is complicated. In addition, the blocking force of the protrusions is relatively weak and the protrusions are easily deformed by pressure from the spring. Under these conditions the protrusion may fail and the inserted parts easily escape from the can.

Therefore, there is room for improvement within the art.

### BRIEF DESCRIPTION OF THE DRAWINGS

Many aspects of the present hinge assembly can be better understood with reference to the following drawings. The components in the drawings are not necessarily drawn to scale, the emphasis instead being placed upon clearly illustrating the principles of the present hinge assembly. Moreover, in the drawings, like reference numerals designate corresponding parts throughout the several views.

FIG. 1 is an exploded, isometric view of a hinge assembly according to an exemplary embodiment.

FIG. 2 is similar to FIG. 1, but shown from another aspect.

FIG. 3 is an assembled view of the hinge assembly shown in FIG. 1.

FIG. 4 is an assembled view of the hinge assembly of FIG. 3 after the sleeve is deformed by a punch press process.

FIG. 5 is an exploded, isometric view of a hinge assembly according to another exemplary embodiment.

FIG. 6 is an assembled view of the hinge assembly shown in FIG. 5.

FIG. 7 is an assembled view of a hinge assembly according to another exemplary embodiment.

### DETAILED DESCRIPTION

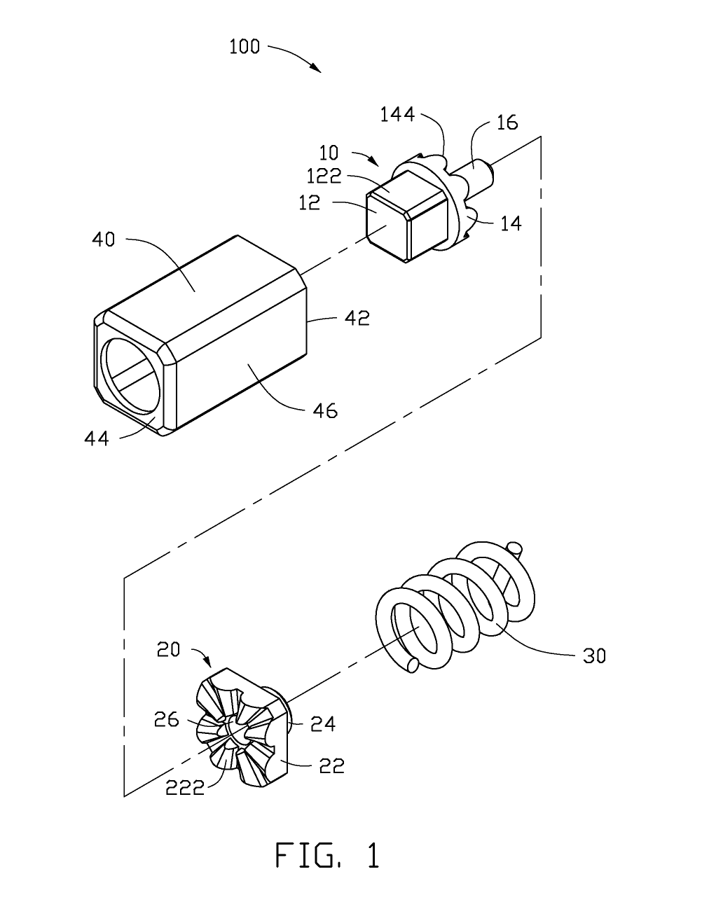

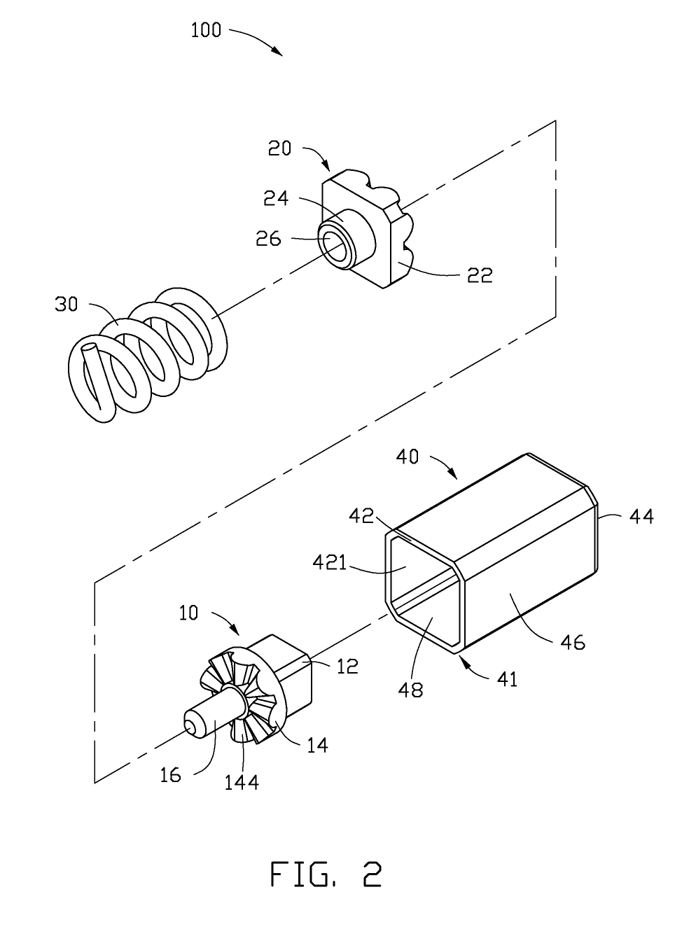

FIGS. 1 and 2 show a hinge assembly 100 according to an exemplary embodiment of the present hinge system. The hinge assembly 100 includes a first member 10, a second member 20, and a resilient member 30, all accommodated in a sleeve 40.

The first member 10 coaxially includes a head portion 12, a cam portion 14, and a shaft portion 16 integrally formed together. The head portion 12 is for engaging with a body section of a foldable electronic device. In an exemplary embodiment, the head portion 12 is substantially cubic, and includes a plurality of planar surfaces 122. The cam portion 14 is formed at one side of the head portion 12, and has a larger radius than the head portion 12. The cam portion 14 includes a cam surface 144. Each cam surface 144 includes a plurality of peaks and valleys. The shaft portion 16 extends from a central area of the cam portion 14 far away from the head portion 12.

The second member 20 includes a latching cam portion 22 and a guiding shaft 24 extending from the latching cam portion 22. The latching cam portion 22 includes a plurality of planar surfaces for slidable and non-rotatable engagement with the sleeve 40. The latching cam portion 22 includes a latching cam surface 222 for engaging with the cam surfaces 144 of the first member 10. The guiding shaft 24 is integrally formed with the latching cam portion 22. A longitudinal passage 26 is defined in the second member 20 for communicating the latching cam portion 22 with the guiding shaft 24.

The resilient member 30 can be spiral-shaped (e.g. a coil spring). The resilient member 30 exerts elastic force on the second member 20 to push the second member 20 toward the first member 10. The resilient member 30 has an inside diameter which is large enough to allow it to be fit over the guiding shaft 24.

The sleeve 40 is a hollow container. In this exemplary embodiment, the sleeve 40 is substantially cubic and is for being non-rotatably connected to a cover section of a foldable electronic device. The sleeve 40 includes a first end 41, a second end 44, and a sleeve wall 46. The first end 41 is opposite to the second end 44, and defines an opening 421 having a rim 42. The rim 42 is ring-shaped. The second end 44 is a partially closed end. A receiving cavity 48 is defined in the sleeve wall 46. The first member 10, the second member 20, and the resilient member 30 can be assembled into the receiving cavity 48 directly through the opening 421.

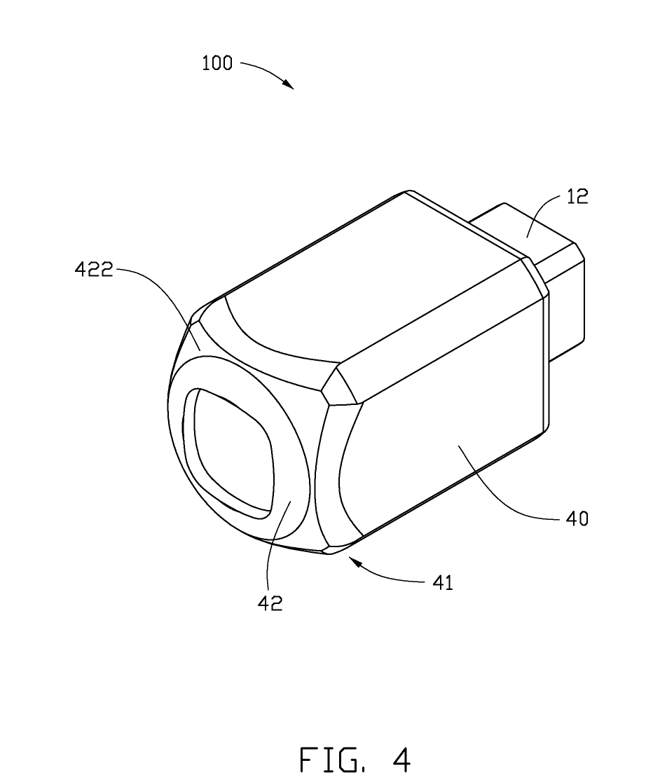

Referring to FIG. 4, the rim 42 of the first end 41 is deformed to form a narrowed portion 422 that decreases the size of the opening 421. In this exemplary embodiment, the narrowed portion 422 is formed by punching/extrusion/deform the rim 41 of the sleeve wall 46 at positions adjacent to the first end 41. The narrowed portion 422 reduces the size of the opening 421 by just enough to prevent the elements contained in the sleeve 40 from separating from the sleeve 40. Naturally the sleeve 40 will be shorter after the narrowed portion 422 is formed because the rim 42 of the sleeve wall 46, itself, is deformed inwardly to form the narrowed portion 422.

In this exemplary embodiment, the narrowed portion 422 approximately tapers at an angle of about 45 degrees relative to the sleeve wall 46.

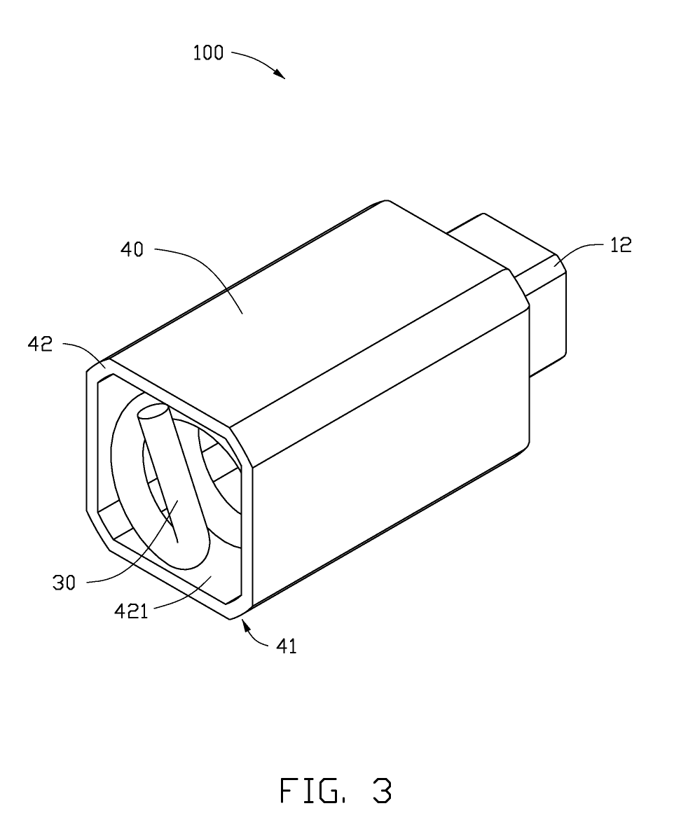

Referring to FIGS. 3 and 4, the first member 10, the second member 20, the resilient member 30 are orderly received in the sleeve 40. The latching cam surface 222 of the second member 20 engages with the cam surface 144 of the first member 10. One end of the resilient member 30 abuts against the second member 20. The head portion 12 is exposed from the sleeve 40. The rim 42 of first end 41 is processed to form the narrowed portion 422 at the first end 41 to abut against the resilient member 30. The first member 10, the second member 20 and the resilient member 30 are thus positioned in the sleeve 40, but kept from falling out of the sleeve 40 by the narrowed portion 422. Accordingly, the hinge assembly 100 is integrated into a complete unit.

The narrowed portion 422 can be formed by using a punch press process. In punching the sleeve 40, a punch is axially aligned with the sleeve 40, and is opposite to the first end 41. The punch presses the first end 41 from outside to directly form the narrowed portion 422. Alternatively, the punch may be radially aligned with the first end 41 to press the first end 41 to form the narrowed portion 422. Since the narrowed portion 422 are formed after assembling the above elements into sleeve 40 and then only by modifying the shape of opening 421, the assembly process is simple. In addition, the sleeve 40 does not need extra elements such as bendable elongated extensions, etc., to prevent the inner elements inside the sleeve 40 from escaping the sleeve 40. Thus, the hinge assembly 100 includes fewer elements, and costs are greatly reduced and manufacturing simplified.

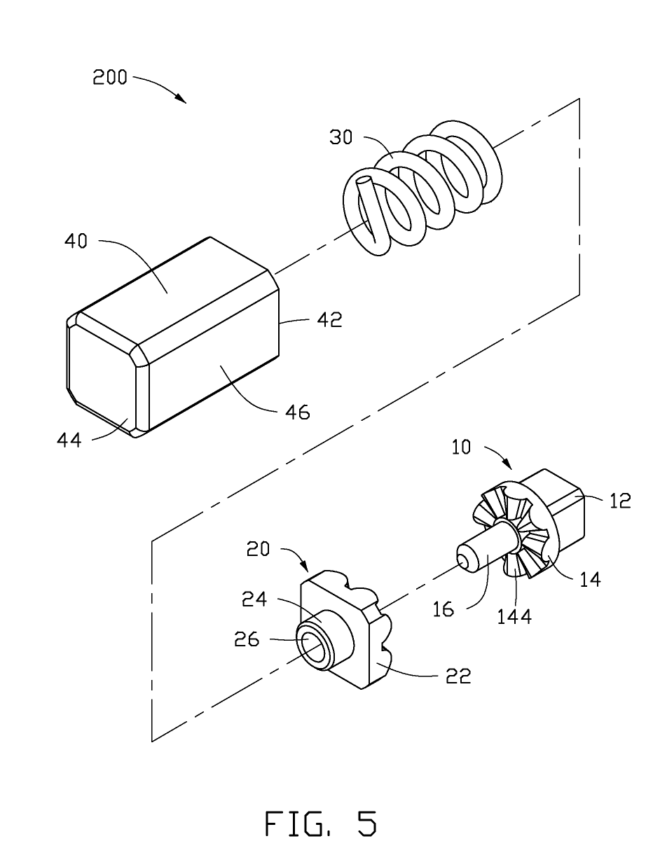

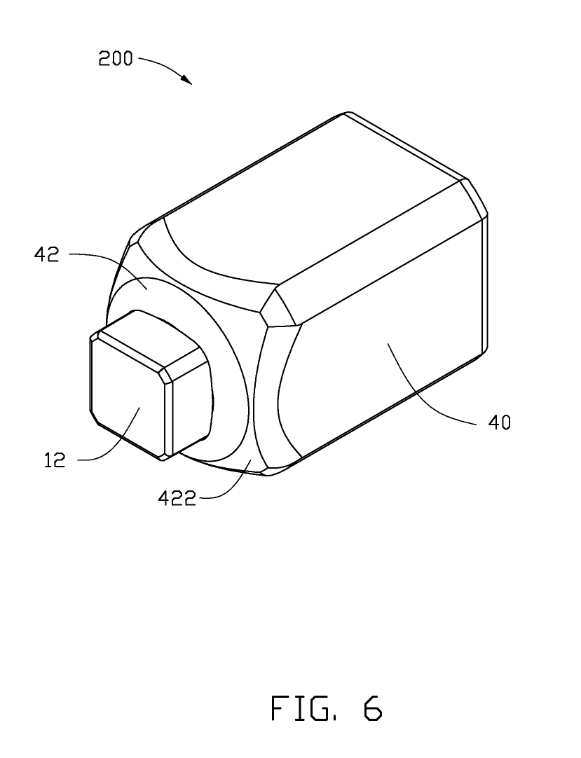

In another exemplary embodiment, referring to FIGS. 5 and 6, the hinge assembly 200 is generally the same as the hinge assembly 100 of the first exemplary embodiment. A difference is that the second end 44 of the sleeve is a completely closed end. One end of the resilient member 30 abuts against the completely closed end, and the other end abuts against the second member 20. The head portion 12 is exposed from the sleeve 40. The first end is processed to form the narrowed portion 422 at the first end 41. The first member 10 thus rotatably protrudes from the sleeve 40, but is kept from falling out of the sleeve 40 by the narrowed portion 422. Accordingly, the hinge assembly 200 is integrated into a complete unit.

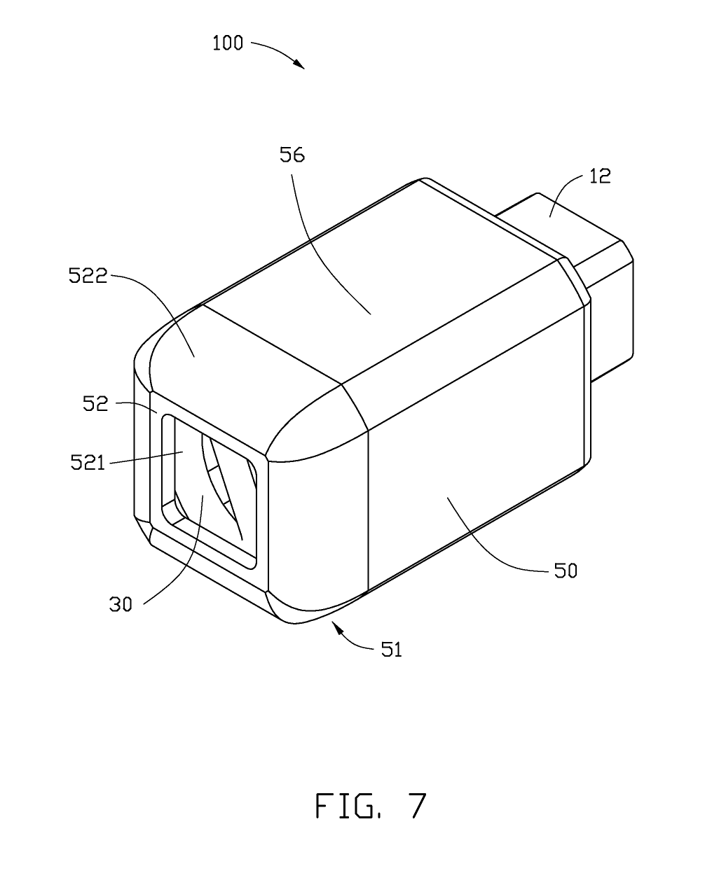

In another embodiment, referring to FIG. 7, after the first member 10, the second member 20, and the resilient member 30 are orderly received in the sleeve 50, a narrowed portion 522 is formed at the first end 52. The narrowed portion 522 has an increasing angle of change through its tapering from the sleeve wall 56 until finally it is substantially perpendicular to the sleeve wall 56.

It should be understood that the cam portions of the first member 10 and the second member 20 may have other shapes. The shape of the cam portion may be changed according to the desired open angle of the cover. It should be understood that one end of the narrowed portion may taper at an angle of about 45 degrees relative to the sleeve wall and the other end of the narrowed portion may be substantially perpendicular to the sleeve wall of the sleeve. The narrowed portion may be substantially conical-shaped or hemisphere-shaped or one part of sphere-shape, and is oriented at an angle relative to the sleeve.

It is to be understood, however, that even though numerous characteristics and advantages of the present embodiments have been set forth in the foregoing description, together with details of the structures and functions of the embodiments, the disclosure is illustrative only, and changes may be made in detail, especially in matters of shape, size, and arrangement of parts within the principles of the disclosure to the full extent indicated by the broad general meaning of the terms in which the appended claims are expressed.

What is claimed is:

1. A hinge assembly comprising:
a sleeve comprising a first end defining an opening;
a first member received in the sleeve;
a second member located next to the first member, one of the first member and the second member having a cam, the other of the first member and the second member having a cam follower interacting with the cam so that the first member rotates about an axis and the second member moves linearly along the axis when the cam follower follows the cam; and
a resilient member being fitted in the sleeve and providing an elastic force to bias the first member and the second member into contact with each other;
wherein the first end is deformed to form a narrowed portion to reduce size of the opening, the narrowed portion retaining the first member, the second member, and the resilient member in the sleeve and preventing the first member, the second member, and the resilient member from escaping the sleeve through the opening.

2. The hinge assembly as claimed in claim 1, wherein the portion of the first end that is deformed to form the narrowed portion is a rim of the first end.

3. The hinge assembly as claimed in claim 1, wherein the narrowed portion tapers at an angle of about 45 degrees relative to the sleeve wall.

4. The hinge assembly as claimed in claim 1, wherein the narrowed portion is substantially perpendicular to the sleeve wall of the sleeve.

5. The hinge assembly as claimed in claim 1, wherein a portion of the narrowed portion tapers at an angle of about 45 degrees relative to the sleeve wall and a portion of the narrowed portion is substantially perpendicular to the sleeve wall of the sleeve.

6. The hinge assembly as claimed in claim 1, wherein the sleeve includes a second end opposite to the first end, the second end is a completely closed end, and the resilient member abuts against the completely closed end.

7. The hinge assembly as claimed in claim 6, wherein the first member includes a head portion and the cam, the head portion exposed from the first end, and the narrowed portion abut against the head portion of the cam.

8. The hinge assembly as claimed in claim 1, wherein the sleeve includes a second end opposite to the first end, the second end is a partially closed end, and one end of the resilient member faces the open end.

9. The hinge assembly as claimed in claim 8, wherein the first member includes a head portion and the cam, and the head portion is exposed from the partially closed end.

10. A hinge assembly comprising:
a first member rotatable about an axis;
a second member located next to the first member, the second member linearly movable along the axis;
a resilient member locating next to the second member and providing an elastic force to bias the first member and the second member into contact with each other;
a sleeve enclosing the first member, the second member, and the resilient member along the axis, the sleeve including a sleeve wall defining a receiving cavity;
wherein a narrowed portion is formed by inwardly deforming the sleeve wall to shorten the receiving cavity for preventing the first member, second member, and resilient members from escaping the sleeve.

11. The hinge assembly as claimed in claim 10, wherein the narrowed portion is substantially conical-shaped, and is oriented at an angle relative to the sleeve.

12. The hinge assembly as claimed in claim 10, wherein the narrowed portion is substantially perpendicular to the sleeve wall of the sleeve.

13. The hinge assembly as claimed in claim 10, wherein a portion of the narrowed portion tapers at an angle of about 45 degrees relative to the sleeve wall and a portion of the narrowed portion is substantially perpendicular to the sleeve wall of the sleeve.

14. The hinge assembly as claimed in claim 10, wherein the sleeve includes a second end opposite to the first end, the second end is a completely closed end, and the resilient member abuts against the completely closed end.

15. The hinge assembly as claimed in claim 14, wherein the first member includes a head portion and the cam, the head portion exposed from the first end, and the narrowed portion abut against the cam.

16. The hinge assembly as claimed in claim 10, wherein the sleeve includes a second end opposite to the first end, the second end is a partially closed end, and one end of the resilient member faces the open end.

17. The hinge assembly as claimed in claim 16, wherein the first member includes a head portion and the cam, and the head portion exposed from the partially closed end.

18. A method for assembling a hinge assembly comprising:
providing a sleeve with a sleeve wall defining a receiving cavity and a first end having a rim, a first member, a second member and a resilient member;
receiving the first member, the second member and the resilient member in the receiving cavity of the sleeve through the first end;
deforming the rim of the first end to form the narrowed portion to retain the first member, the second member, and the resilient member in the sleeve.
